(19) United States
(12) Patent Application Publication
(10) Pub. No.: US 2015/0248865 A1
(43) Pub. Date: Sep. 3, 2015

(54) DISPLAY APPARATUS

(71) Applicant: Samsung Display Co., LTD., Yongin-City (KR)

(72) Inventors: Han-Byul LIM, Daejeon (KR); Hye-Na KANG, Incheon (KR); Kyu-Min KWON, Cheonan-si (KR); Min-Hyoung KIM, Daegu (KR); Kyeong-Seok LEE, Busan (KR); Dae-Ho HWANG, Asan-si (KR); Jun-Hyuck HWANG, Asan-si (KR)

(21) Appl. No.: 14/325,226

(22) Filed: Jul. 7, 2014

(30) Foreign Application Priority Data
Feb. 28, 2014 (KR) 10-2014-0024072

(51) Int. Cl. G09G 3/36; G09G 5/10

(52) U.S. Cl. CPC G09G 3/3607; G09G 3/3696; G09G 3/3659; G09G 5/10; G09G 2320/0233; G09G 2320/0276; G09G 2320/043

(57) ABSTRACT

A display apparatus includes a display panel comprising a plurality of data lines and a plurality of gate lines crossing the plurality of data lines, and a memory configured to store a plurality of gamma voltage data respectively corresponding to a plurality of partial areas of the display panel, the plurality of gamma voltage data for compensating a gamma difference between the partial areas of the display panel. The display apparatus further includes a timing controller configured to read, from the memory, the plurality of gamma voltage data respectively corresponding to the plurality of partial areas, and a plurality of data driver circuits configured to generate, based on the plurality of gamma voltage data, a plurality of grayscale voltages to be applied to the plurality of data lines in the plurality of partial areas.

This application claims priority from and the benefit of Korean Patent Application No. 10-2014-0024072 filed on Feb. 28, 2014, which is hereby incorporated by reference in its entirety.

### BACKGROUND

1. Technical Field

The present disclosure relates to a display apparatus. More particularly, it discloses a display apparatus having uniform luminance.

2. Description of the Related Art

Generally, a liquid crystal display (LCD) apparatus has relatively thin form factor, is light weight, and consumes low power. As such, the LCD apparatus is commonly used in monitors, laptop computers, cellular phones, etc. The LCD apparatus typically includes an LCD panel that is capable of displaying images using light transmittance of a liquid crystal, a backlight assembly disposed beneath the LCD panel for providing light to the LCD panel, and a driving circuit for driving the LCD panel.

The LCD panel may further include an array substrate, an opposing substrate disposed opposite to the array substrate, and a liquid crystal layer disposed between the array substrate and the opposing substrate. The array substrate includes a gate line, a data line, a thin film transistor, and a pixel electrode, and the opposing substrate includes a common electrode. The driving circuit includes a gate driving part for driving the gate line and a data driving part for driving the data line.

As the surface area of an LCD panel increases, a resistance-capacitance (RC) time delay of gate signals transferred through the gate lines and data signals transferred through the data lines increases. The increase in RC time delay may affect display quality. For example, the RC time delay of the gate signals may occur in an area that is relatively far away from the gate driving part (the gate driving part being configured to output the gate signal). Because the gate signals are typically used to control a charging period of pixels when data signals are sent to the pixels, a charging ratio may be decreased by the RC time delay of the gate signals. The RC time delay may cause the display quality (for example, a luminance difference, etc.) to deteriorate.

### SUMMARY

According to an exemplary embodiment of the inventive concept, a display apparatus is provided. The display apparatus comprises: a display panel including a plurality of data lines and a plurality of gate lines crossing the plurality of data lines; a memory configured to store a plurality of gamma voltage data respectively corresponding to a plurality of partial areas of the display panel, the plurality of gamma voltage data for compensating a gamma difference between the partial areas of the display panel; a timing controller configured to read, from the memory, the plurality of gamma voltage data respectively corresponding to the plurality of partial areas; and a plurality of data driver circuits configured to generate, based on the plurality of gamma voltage data, a plurality of grayscale voltages to be applied to the plurality of data lines in the plurality of partial areas.

In an exemplary embodiment, the plurality of gamma voltage data may correspond to a plurality of sample grayscales.

In an exemplary embodiment, the display apparatus may further include: a reference gamma voltage generator configured to generate a first white voltage and a first black voltage of a first polarity, and a second white voltage and a second black voltage of a second polarity, wherein the second polarity is opposite to the first polarity with respect to a reference voltage, wherein the reference gamma voltage generator may be further configured to provide the plurality of data driver circuits with the first white voltage, the first black voltage, the second white voltage, and the second black voltage.

In an exemplary embodiment, each of the plurality of data driver circuits may be configured to convert image data into a grayscale voltage using the first white voltage, the first black voltage, the second white voltage, the second black voltage, and the plurality of gamma voltage data.

In an exemplary embodiment, at least one of the data driver circuits may be configured to drive the plurality of data lines in at least one of the partial areas.

In an exemplary embodiment, the plurality of partial areas may include a central area of the display panel, a left side area which is located at a left side with respect to the central area, and a right side area which is located at a right side with respect to the central area.

In an exemplary embodiment, the plurality of data driver circuits may include at least one first data driver circuit configured to drive the plurality of data lines in the central area, at least one second data driver circuit configured to drive the plurality of data lines in the left area, and at least one third data driver circuit configured to drive the plurality of data lines in the right area.

In an exemplary embodiment, the timing controller may be configured to provide the first data driver circuit with a first gamma voltage data, and to provide the second and third data driver circuits with a second gamma voltage data which is different from the first gamma voltage.

In an exemplary embodiment, the timing controller may be configured to provide the first data driver circuit with a first gamma voltage data, to provide the second data driver circuit with a second gamma voltage data which is different from the first gamma voltage data, and to provide the third data driver circuit with a third gamma voltage data which is different from the first and second gamma voltage data.

In an exemplary embodiment, each of the plurality of data lines may be divided into an upper data line disposed in an upper area of the display panel and a lower data line disposed in a lower area of the display panel, the upper data line being spaced apart from the lower data line.

In an exemplary embodiment, the plurality of partial areas may include a first central area, a first left side area, and a first right side area which are located in the upper area, and a second central area, a second left side area, and a second right side area which are located in the lower area, wherein the first left side area and the first right side area are located with respect to the first central area, and the second left side area and the second right side area are located with respect to the second central area.

In an exemplary embodiment, the plurality of data driver circuits may include at least one first data driver circuit configured to drive the plurality of data lines in the first central area, at least one second data driver circuit configured to drive the plurality of data lines in the first left area, at least one third data driver circuit configured to drive the plurality of data lines in the first right area, at least one fourth data driver circuit configured to drive the plurality of data lines in the second central area, at least one fifth data driver circuit configured to drive the plurality of data lines in the second left area, and at least one sixth data driver circuit configured to drive the plurality of data lines in the second right area.

In an exemplary embodiment, the first to sixth data driver circuits may be further configured to receive the plurality of gamma voltage data, with each data driver circuit receiving a different gamma voltage data.

In an exemplary embodiment, the display apparatus may further include a first timing controller configured to provide the first, second, and third data driver circuits with the plurality of gamma voltage data, and a second timing controller configured to provide the fourth, fifth, and sixth driver circuits with the plurality of gamma voltage data.

In an exemplary embodiment, the first and second timing controllers may be configured to provide the first and fourth data driver circuits with a plurality of first gamma voltage data, and to provide the second, third, fifth, and sixth data driver circuits with a plurality of second gamma voltage data which are different from the first gamma voltage data.

In an exemplary embodiment, the first timing controller may be configured to provide the first data driver circuit with a first gamma voltage data, to provide the second data driver circuit with a second gamma voltage data, and to provide the third data driver circuit with a third gamma voltage data, and the second timing controller may be configured to provide the fourth data driver circuit with a fourth gamma voltage data, to provide the fifth data driver circuit with a fifth gamma voltage data, and to provide the sixth data driver circuit with a sixth gamma voltage data.

According to the inventive concept, a gamma curve may be differentially applied to every partial area of the display panel such that the gamma difference between the partial areas may be decreased. Thus, luminance difference (which occurs when the number and length of the gate lines and data lines are increased) may be improved.

### BRIEF DESCRIPTION OF THE DRAWINGS

The above and other features and advantages of the inventive concept will be more apparent when exemplary embodiments of the inventive concept are described with reference to the accompanying drawings.

FIG. 1 is a block diagram illustrating a display apparatus according to an exemplary embodiment.

FIG. 2 is a conceptual diagram illustrating the plurality of gamma voltage data stored in the memory of FIG. 1.

FIGS. 3A and 3B are block diagrams illustrating the plurality of data driver circuits of FIG. 1.

FIG. 4 is a block diagram illustrating a display apparatus according to another exemplary embodiment.

### DETAILED DESCRIPTION

Hereinafter, the inventive concept will be explained in detail with reference to the accompanying drawings.

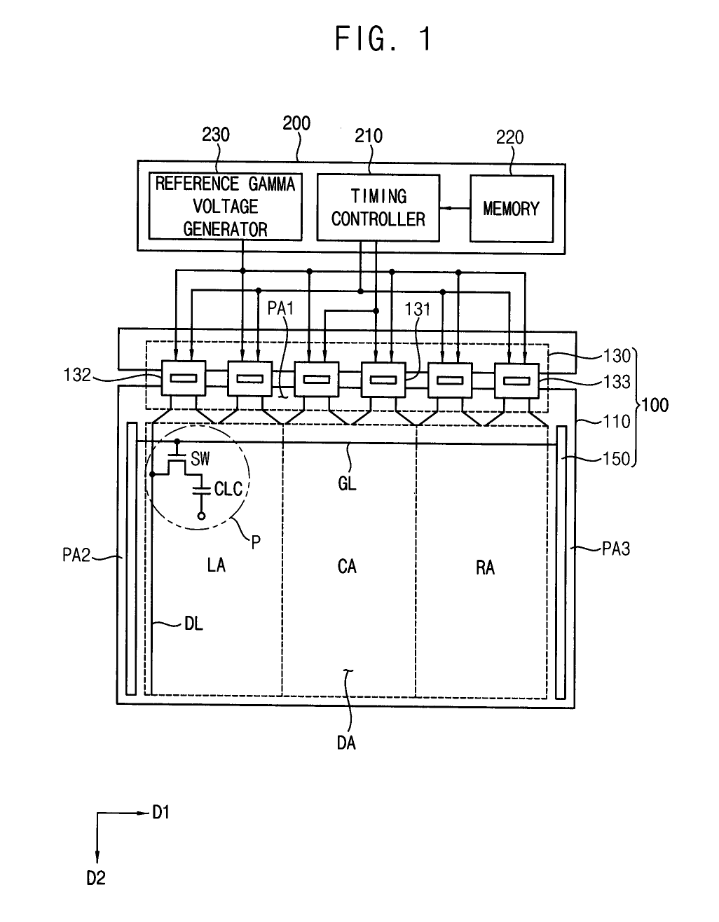

FIG. 1 is a block diagram illustrating a display apparatus according to an exemplary embodiment.

Referring to FIG. 1, the display apparatus may include a panel module 100 and a driving module 200.

The panel module 100 may include a display panel 110, a data driving part 130, and a gate driving part 150.

The display panel 110 may include a display area DA and a plurality of peripheral areas surrounding the display area DA.

A plurality of data lines DL, a plurality of gate lines GL, and a plurality of pixels P are disposed in the display area DA. The gate lines GL extend in a first direction D1 and are arranged in a second direction D2 crossing the first direction D1. The data lines DL extend in the second direction D2 and are arranged in the first direction D1. The pixels P are electrically connected to the gate lines GL and the data lines DL.

Each of the pixels P may include a switching element SW, a liquid crystal capacitor CLC electrically connected to the switching element SW, and a storage capacitor (not shown). The pixels P may be arranged in a matrix form.

The data driving part 130 includes a plurality of data driver circuits. The plurality of data driver circuits is mounted on a first peripheral area PA1 of the display panel and may be formed as a tape carrier package (“TCP”) including a driver chip.

The plurality of data driver circuits includes at least one first data driver circuit 131, at least one second data driver circuit 132, and at least one third data driver circuit 133. The at least one first data driver circuit 131 is configured to provide the data lines in a central area CA of the display panel 110 with grayscale voltages. The at least one second data driver circuit 132 is configured to provide the data lines in a left side area LA of the display panel 110 with grayscale voltages. The at least one third data driver circuit 133 is configured to provide the data lines in a right side area RA of the display panel 110 with grayscale voltages.

The gate driving part 150 includes at least one gate driver circuit. The gate driver circuit may be disposed in one of a second peripheral area PA2 and a third peripheral area PA3 that is opposite to the second peripheral area PA2. Alternatively, the gate driving part 150 may be disposed in each of the second peripheral area PA2 and the third peripheral area PA3.

The gate driver circuit may be formed as the TCP including a driver chip and may be mounted on each of the second and third peripheral areas PA2 and PA3, as shown in FIG. 1. Alternatively, the gate driver circuit may be directly integrated in the second and third peripheral areas PA2 and PA3 via manufacturing processes which are substantially the same as those for manufacturing the switching element SW in the pixel P.

The driving module 200 includes a timing controller 210, a memory 220, and a reference gamma voltage generator 230.

The timing controller 210 generally controls a driving timing of the display apparatus. The timing controller 210 is configured to read a plurality of gamma voltage data from the memory 220 and to provide the plurality of data driver circuits 131, 132, and 133 with the plurality of gamma voltage data.

The memory 220 stores the plurality of gamma voltage data corresponding to a plurality of gamma curves. The memory 220 may be an EEPROM (Electrically Erasable and Programmable Read Only Memory).

For example, the memory 220 may store the plurality of gamma voltage data respectively corresponding to K sample grayscales in accordance with a first gamma curve, and the plurality of gamma voltage data respectively corresponding to K sample grayscales in accordance with a second gamma curve (where ‘K’ is a natural number). The gamma voltage data include digital signals. As described above, the memory 220 may store the plurality of gamma voltage data in accordance with N gamma curves (where ‘N’ is a natural number). The N gamma curves may be determined respectively corresponding to the plurality of partial areas of the display panel 110 such that a luminance difference between the partial areas of the display panel 110 may be decreased. A luminance difference of the display panel 110 may occur in a large-sized and high resolution display panel having an increased number and length of gate lines and data lines.

A gamma curve of the central area CA may be determined as a first gamma curve, and a gamma curve of the left and right side areas may be determined as a second gamma curve which is to compensate a gamma difference with respect to the central area CA. Thus, the gamma difference between the central area CA and the left side area LA may be improved, and the gamma difference between the central area CA and the right side area RA may also be improved. Therefore, the partial areas CA, LA, and RA of the display panel 110 may have uniform luminance.

The reference gamma voltage generator 230 is configured to generate a plurality of reference gamma voltages which are analog signals. For example, the plurality of reference gamma voltages may include a first white voltage and a first black voltage of a first polarity (+), and a second white voltage and a second black voltage of a second polarity (−) that is opposite to the first polarity (+) with respect to a reference voltage. The reference gamma voltage generator 230 is configured to provide the plurality of data driver circuits 131, 132, and 133 with the first white voltage, the first black voltage, the second white voltage, and the second black voltage.

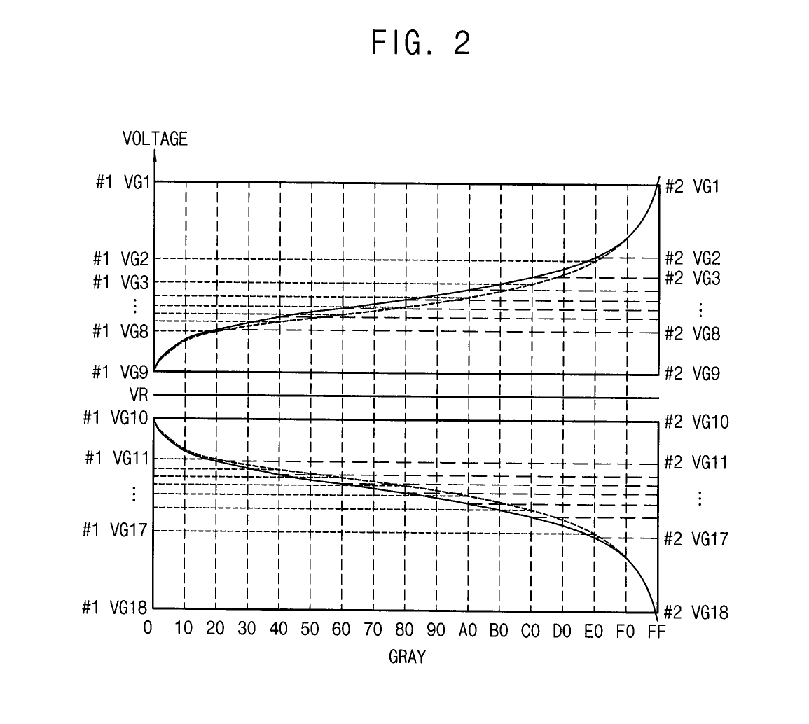

FIG. 2 is a conceptual diagram illustrating a plurality of gamma voltage data stored in the memory 220 of FIG. 1.

Referring to FIGS. 1 and 2, the memory 220 stores a plurality of gamma voltage data #1VG1, . . . , #1VG18 in accordance with a first gamma curve, and a plurality of gamma voltage data #2VG1, . . . , #2VG18 in accordance with a second gamma curve. The plurality of gamma voltage data correspond to a plurality of sample grayscales and include digital signals.

In accordance with the first gamma curve, first gamma voltage data #1VG1 may correspond to a first white voltage VGMA_UU of the first polarity (+), and ninth gamma voltage data #1VG9 may correspond to a first black voltage VGMA_UL of the first polarity (+).

In accordance with the first gamma curve, tenth gamma voltage data #1VG10 may correspond to a second black voltage VGMA_LL of the second polarity (−), and eighteenth gamma voltage data #1VG18 may correspond to a second white voltage VGMA_LU of the second polarity (−).

Therefore, the memory 220 may store second to eighth gamma voltage data #1VG2˜#1VG8 of the first polarity (+) and eleventh to seventeenth gamma voltage data #1VG11˜#1VG17 of the second polarity (−), in accordance with the first gamma curve.

In accordance with the second gamma curve, first gamma voltage data #2VG1 may correspond to a first white voltage VGMA_UU of the first polarity (+), and ninth gamma voltage data #2VG9 may correspond to a first black voltage VGMA_UL of the first polarity (+).

In accordance with the second gamma curve, tenth gamma voltage data #2VG10 may correspond to a second black voltage VGMA_LL of the second polarity (−), and eighteenth gamma voltage data #2VG18 may correspond to a second black voltage VGMA_LL of the second polarity (−).

Therefore, the memory 220 stores second to eighth gamma voltage data #2VG2˜#2VG8 of the first polarity (+) and eleventh to seventeenth gamma voltage data #2VG11˜#2VG17 of the second polarity (−), in accordance with the second gamma curve.

As described above, the memory 220 stores the plurality of gamma voltage data corresponding to the first and second gamma curves. However, the inventive concept is not limited thereto. In some embodiments, the memory 220 may store a plurality of gamma voltage data corresponding to a plurality of gamma curves such that the gamma difference between the partial areas of the display panel 110 may be improved.

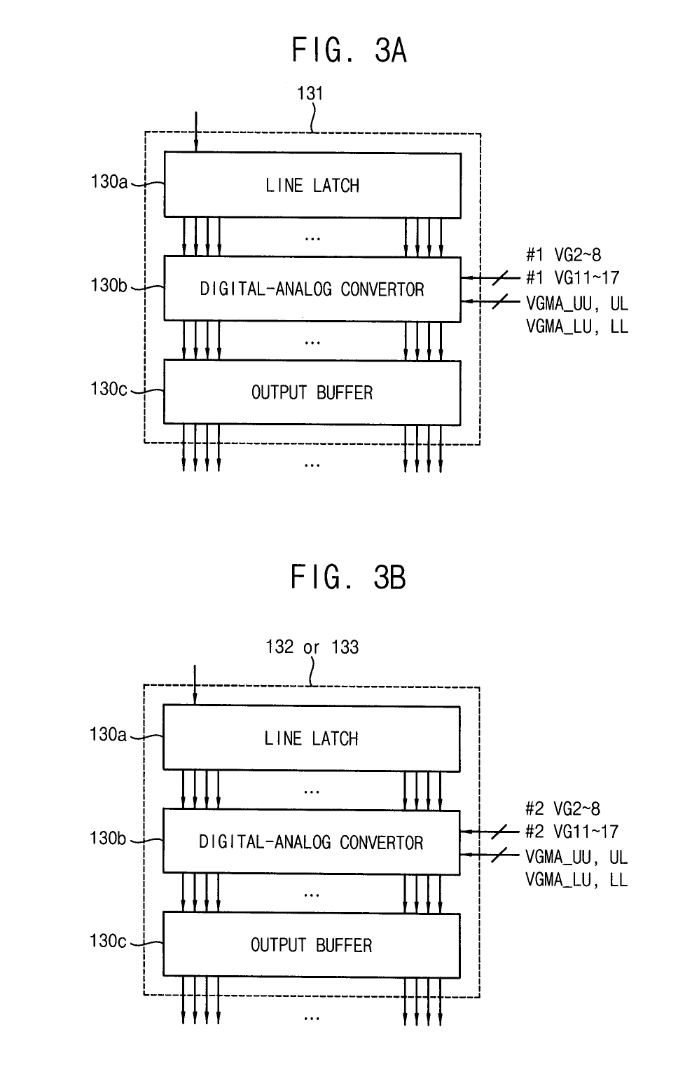

FIGS. 3A and 3B are block diagrams illustrating the plurality of data driver circuits of FIG. 1.

Referring to FIGS. 1, 3A, and 3B, each of the first, second, and third data driver circuits 131, 132, and 133 may include a line latch 130a, a digital-analog convertor 130b, and an output buffer 130c.

The line latch 130a latches image data received from the timing controller 210 by a horizontal period. The image data includes digital signals. The line latch 130a outputs latched image data in response to a load signal received from the timing controller 210.

The digital-analog convertor 130b converts the image data (digital signal) to a grayscale voltage (analog signal).

For example, the digital-analog convertor 130b can convert the image data to the grayscale voltage using the plurality of reference gamma voltages (analog signals provided from the reference gamma voltage generator 230) and the plurality of gamma voltage data (digital signals provided from the timing controller 210). The plurality of reference gamma voltages include the first white voltage VGMA_UU and the first black voltage VGMA_UL of the first polarity (+), and the second white voltage VGMA_LU and the second black voltage VGMA_LL of the second polarity (−).

The output buffer 130c may include a plurality of amplifiers. The output buffer 550 is configured to amplify the grayscale voltage and to output the grayscale voltage to the data line DL of the display panel 110. The output buffer 130c outputs the grayscale voltage by a horizontal period.

As previously described, the first data driver circuit 131 drives the data line in the central area CA. Referring to FIG. 3A, the digital-analog convertor 130b of the first data driver circuit 131 receives the second to eighth gamma voltage data #1VG2˜#1VG8 of the first polarity (+) and the eleventh to seventeenth gamma voltage data #1VG11˜#1VG17 of the second polarity (−) corresponding to the first gamma curve form the timing controller 210. In other words, the timing controller 210 reads the second to eighth gamma voltage data #1VG2˜#1VG8 of the first polarity (+) and the eleventh to seventeenth gamma voltage data #1VG11˜#1VG17 of the second polarity (−) corresponding to the first gamma curve for the central area CA from the memory 220, and provides the digital-analog convertor 130b of the first data driver circuit 131 with the plurality of gamma voltage data #1VG2˜#1VG8 and #1VG11˜#1VG17 corresponding to the first gamma curve.

The digital-analog convertor 130b of the first data driver circuit 131 receives the reference gamma voltages (analog signals) which include the first white voltage VGMA_UU, the first black voltage VGMA_UL, the second white voltage VGMA_LU, and the second black voltage VGMA_LL, from the reference gamma voltage generator 230.

The first data driver circuit 131 converts the image data to the grayscale voltage using the reference gamma voltages VGMA_UU, VGMA_UL, VGMA_LU, and VGMA_LL, and the second to eighth gamma voltage data #1VG2˜#1VG8 and the eleventh to seventeenth gamma voltage data #1VG11˜#1VG17 corresponding to the first gamma curve.

Therefore, the plurality of pixels in the central area CA may display an image based on the first gamma curve.

As previously described, the second data driver circuit 132 drives the data line in the left side area LA. Referring to FIG. 3B, the digital-analog convertor 130b of the second data driver circuit 132 receives the second to eighth gamma voltage data #2VG2˜#2VG8 of the first polarity (+) and the eleventh to seventeenth gamma voltage data #2VG11˜#2VG17 of the second polarity (−) corresponding to the second gamma curve from the timing controller 210. In other words, the timing controller 210 reads the second to eighth gamma voltage data #2VG2˜#2VG8 of the first polarity (+) and the eleventh to seventeenth gamma voltage data #2VG11˜#2VG17 of the second polarity (−) corresponding to the second gamma curve for the left side area LA from the memory 220, and provides the digital-analog convertor 130b of the second data driver circuit 132 with the plurality of gamma voltage data #2VG2˜#2VG8 and #2VG11˜#2VG17 corresponding to the second gamma curve.

The digital-analog convertor 130b of the second data driver circuit 132 receives the reference gamma voltages (analog signals) which include the first white voltage VGMA_UU, the first black voltage VGMA_UL, the second white voltage VGMA_LU, and the second black voltage VGMA_LL, from the reference gamma voltage generator 230.

The second data driver circuit 132 converts the image data to the grayscale voltage using the reference gamma voltages VGMA_UU, VGMA_UL, VGMA_LU, and VGMA_LL, and the second to eighth gamma voltage data #2VG2˜#2VG8 and the eleventh to seventeenth gamma voltage data #2VG11˜#2VG17 corresponding to the second gamma curve.

Therefore, the plurality of pixels in the left side area LA may display an image based on the second gamma curve. The second gamma curve is to compensate the gamma difference between the central area CA and the left side area LA, and thus the luminance difference between the image displayed on the left side area LA and the image displayed on the central area CA may be improved.

As previously described, the third data driver circuit 133 drives the data line in the right side area RA. The digital-analog convertor 130b of the third data driver circuit 133 receives the second to eighth gamma voltage data #2VG2˜#2VG8 of the first polarity (+) and the eleventh to seventeenth gamma voltage data #2VG11˜#2VG17 of the second polarity (−) corresponding to the second gamma curve form the timing controller 210. In other words, the timing controller 210 reads the second to eighth gamma voltage data #2VG2˜#2VG8 of the first polarity (+) and the eleventh to seventeenth gamma voltage data #2VG11˜#2VG17 of the second polarity (−) corresponding to the second gamma curve for the right side area RA from the memory 220, and provides the digital-analog convertor 130b of the third data driver circuit 133 with the plurality of gamma voltage data #2VG2˜#2VG8 and #2VG11˜#2VG17 corresponding to the second gamma curve.

The digital-analog convertor 130b of the third data driver circuit 133 receives the reference gamma voltages (analog signals) which include the first white voltage VGMA_UU, the first black voltage VGMA_UL, the second white voltage VGMA_LU, and the second black voltage VGMA_LL, from the reference gamma voltage generator 230.

The third data driver circuit 133 converts the image data to the grayscale voltage using the reference gamma voltages VGMA_UU, VGMA_UL, VGMA_LU, and VGMA_LL, and the second to eighth gamma voltage data #2VG2˜#2VG8 and the eleventh to seventeenth gamma voltage data #2VG11˜#2VG17 corresponding to the second gamma curve.

Therefore, the plurality of pixels in the right side area RA may display an image based on the second gamma curve. The second gamma curve is to compensate the gamma difference between the central area CA and the right side area RA, and thus the luminance difference between the image displayed on the right side area RA and the image displayed on the central area CA may be improved.

As described above, the same gamma curve is applied to the left side area LA and the right side area RA in order to compensate the gamma difference with respect to the central area. However, the inventive concept is not limited thereto. In some embodiments, the gamma curve applied to the left side area LA may be different from the gamma curve applied to the right side area RA according to a characteristic of the display panel 110. In those embodiments, the memory 220 may store a plurality of gamma voltage data corresponding to the gamma curve for the left side area LA and a plurality of gamma voltage data corresponding to the gamma curve for the right side area RA.

Therefore, the gamma curve may be differentially applied to every partial area of the display panel 110 such that the gamma difference between the partial areas may be decreased. Thus, the luminance difference of the display panel 110 may be improved.

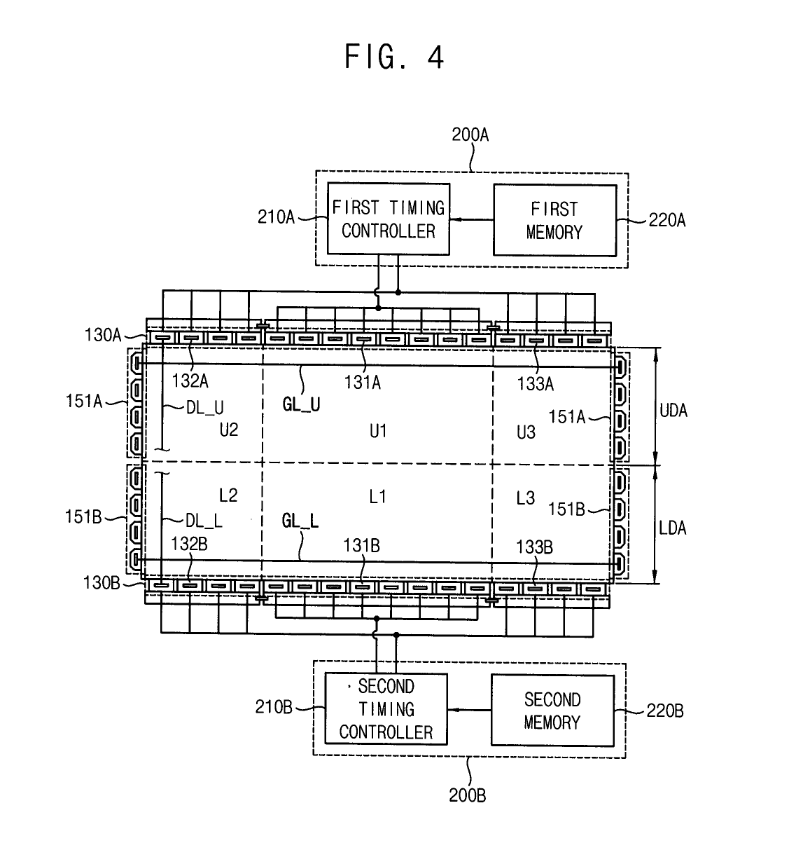

FIG. 4 is a block diagram illustrating a display apparatus according to another exemplary embodiment.

Hereinafter, the same reference numerals are used to refer to the same or like parts as those described in the previous exemplary embodiments. In the interest of clarity, some of the previously described parts may be omitted from the illustration in FIG. 4.

Referring to FIG. 4, the display apparatus may include a panel module and a driving module.

The panel module includes a display panel 110, a first data driving part 130A, a second data driving part 130B, a first gate driving part 150A, and a second gate driving part 150B.

The display panel 110 includes a display area DA and a plurality of peripheral areas surrounding the display area DA.

A plurality of data lines DL, a plurality of gate lines GL, and a plurality of pixels P are disposed in the display area DA. The gate lines GL extend in a first direction D1 and are arranged in a second direction D2 crossing the first direction D1. The data lines DL extend in the second direction D2 and are arranged in the first direction D1. The pixels P are electrically connected to the gate lines GL and the data lines DL.

In an exemplary embodiment, the display area DA is divided into an upper display area UDA and a lower display area LDA. A plurality of pixels in a same pixel column is connected to an upper data line DL_U disposed in the upper display area UDA and a lower data line DL_L disposed in the lower display area LDA. The upper data line DL_U is spaced apart from the lower data line DL_L.

The first data driving part 130A includes a plurality of data driver circuits which are configured to drive a plurality of upper data lines DL_U disposed in the upper display area UDA. The first data driving part 130A includes at least one first data driver circuit 131A, at least one second data driver circuit 132A, and at least one third data driver circuit 133A. The at least one first data driver circuit 131A is configured to drive the upper data lines in a first central area U1 of the upper display area UDA. The at least one second data driver circuit 132A is configured to drive the upper data lines in a first left side area U2 of the upper display area UDA. The at least one third data driver circuit 133A is configured to drive the upper data lines in a first right side area U3 of the upper display area UDA.

The second data driving part 130B includes a plurality of data driver circuits which are configured to drive a plurality of lower data lines DL_L disposed in the lower display area LDA. The second data driving part 130B includes at least one fourth data driver circuit 131B, at least one fifth data driver circuit 132B, and at least one sixth data driver circuit 133B. The at least one fourth data driver circuit 131 B is configured to drive the lower data lines in a second central area L1 of the lower display area LDA. The at least one fifth data driver circuit 132B is configured to drive the lower data lines in a second left side area L2 of the lower display area LDA. The at least one sixth data driver circuit 133B is configured to drive the lower data lines in a second right side area L3 of the lower display area LDA.

The first gate driving part 150A includes at least one gate driver circuit which is configured to drive an upper gate line GL_U disposed in the upper display area UDA. The gate driver circuit may be formed as a TCP as shown in FIG. 4 or may be directly integrated on a peripheral area of the display panel 110.

The second gate driving part 150B includes at least one gate driver circuit which is configured to drive a lower gate line GL_L disposed in the lower display area LDA. The gate driver circuit be formed as a TCP as shown in FIG. 4 or may be directly integrated on a peripheral area of the display panel 110.

The driving module includes a first driving module 200A and a second driving module 200B. The first driving module 200A includes a first timing controller 210A and a first memory 220A. The second driving module 200B includes a second timing controller 210B and a second memory 220B.

The first timing controller 210A controls a driving timing of the first data driving part 130A and the first gate driving part 150A such that an image is displayed on the upper display area UDA of the display panel 110.

The first memory 220A may store the plurality of gamma voltage data corresponding to a plurality of gamma curves which is applied to every partial area of the upper display area UDA. For example, the first memory 220A may store a plurality of gamma voltage data corresponding to a gamma curve for the first central area U1, a plurality of gamma voltage data corresponding to a gamma curve for the first left side area U2, and a plurality of gamma voltage data corresponding to a gamma curve for the first right side area U3.

The first timing controller 210A provides the first, second, and third data driver circuits 131A, 132A, and 133A with the plurality of gamma voltage data respectively corresponding to gamma curves for the first central area U1, the first left side area U2, and the first right side area U3, from the first memory 220A.

The second timing controller 210B controls a driving timing of the second data driving part 130B and the second gate driving part 150B such that an image is displayed on the lower display area LDA of the display panel 110.

The second memory 220B may store the plurality of gamma voltage data corresponding to a plurality of gamma curves which is applied to every partial area of the lower display area LDA. For example, the second memory 220B may store a plurality of gamma voltage data corresponding to a gamma curve for the second central area L1, a plurality of gamma voltage data corresponding to a gamma curve for the second left side area L2, and a plurality of gamma voltage data corresponding to a gamma curve for the second right side area L3.

The second timing controller 220A provides the fourth, fifth, and sixth data driver circuits 131B, 132B, and 133B with the plurality of gamma voltage data respectively corresponding to gamma curves for the second central area L1, the second left side area L2, and the second right side area L3, from the second memory 220B.

For example, the first timing controller 210A is configured to provide the first data driver circuit 131A with a plurality of gamma voltage data corresponding to a first gamma curve, and further configured to provide the second and third data driver circuits 132A and 133A with a plurality of gamma voltage data corresponding to a second gamma curve that is different from the first gamma curve.

The second timing controller 210B is configured to provide the fourth data driver circuit 131 B with a plurality of gamma voltage data corresponding to the first gamma curve, and further configured to provide the fifth and sixth data driver circuits 132B and 133B with a plurality of gamma voltage data corresponding to the second gamma curve.

Therefore, a plurality of pixels in the first and second central areas U1 and L1 may display an image based on the first gamma curve. A plurality of pixels in the first and second left side areas U2 and L2 and the first and second right side areas U3 and L3 may display an image based on the second gamma curve. The second gamma curve is to compensate the gamma difference between the central area, left side and right side areas U1, L1, U2, L2, U3, and L3.

Alternatively, the first timing controller 210A provides the first data driver circuit 131A with the plurality of gamma voltage data corresponding to a first gamma curve. Thus, the plurality of pixels in the first central area U1 may display the image based on the first gamma curve.

The first timing controller 210A provides the second data driver circuit 132A with the plurality of gamma voltage data corresponding to a second gamma curve that is different from the first gamma curve. Thus, the plurality of pixels in the first left side area U2 may display the image based on the second gamma curve. The second gamma curve is to compensate a gamma difference between the first central area U1 and the first left side area U2.

The first timing controller 210A provides the third data driver circuit 133A with the plurality of gamma voltage data corresponding to a third gamma curve that is different from the second gamma curve. Thus, the plurality of pixels in the first right side area U3 may display the image based on the third gamma curve. The third gamma curve is to compensate a gamma difference between the first central area U1 and the first right side area U3.

The second timing controller 210B provides the third data driver circuit 133A with the plurality of gamma voltage data corresponding to a fourth gamma curve that is different from the first to third gamma curves. Thus, the plurality of pixels in the second central area L1 may display the image based on the fourth gamma curve. The fourth gamma curve is to compensate a gamma difference between the first central area U1 and the second central area L1.

The second timing controller 210B provides the fifth data driver circuit 132B with the plurality of gamma voltage data corresponding to a fifth gamma curve that is different from the first to fourth gamma curves. Thus, the plurality of pixels in the second left side area L2 may display the image based on the fifth gamma curve. The fifth gamma curve is to compensate a gamma difference between the first central area U1 and the second left side area L2.

The second timing controller 210B provides the sixth data driver circuit 133B with the plurality of gamma voltage data corresponding to a sixth gamma curve that is different from the first to fifth gamma curves. Thus, the plurality of pixels in the second right side area L3 may display the image based on the sixth gamma curve. The sixth gamma curve is to compensate a gamma difference between the first central area U1 and the second right side area L3.

As described above, each of the upper display area and the lower display area is divided into the left side area, the central area, and the right side area, and the gamma curve is differentially applied to every divided area. However, the inventive concept is not limited thereto. In some embodiments, the display panel may be divided into areas based on the gamma difference of the display panel and the gamma curve may be differentially applied to every divided area.

According to exemplary embodiments of the inventive concept, the gamma curve may be differentially applied to every partial area of the display panel such that the gamma difference between the partial areas may be decreased. Thus, the luminance difference (which occurs when the number and length of the gate line and the data line is increased) may be improved.

The foregoing exemplary embodiments are illustrative of the inventive concept and should not be construed as limiting the inventive concept. Although some exemplary embodiments of the inventive concept have been described, those skilled in the art will readily appreciate that many modifications can be made to the exemplary embodiments without departing from the novel teachings and advantages of the inventive concept. Accordingly, all such modifications are intended to be included within the scope of the inventive concept as defined in the claims.

What is claimed is:

1. A display apparatus comprising:
a display panel comprising a plurality of data lines and a plurality of gate lines crossing the plurality of data lines;
a memory configured to store a plurality of gamma voltage data respectively corresponding to a plurality of partial areas of the display panel, the plurality of gamma voltage data for compensating a gamma difference between the partial areas of the display panel;
a timing controller configured to read, from the memory, the plurality of gamma voltage data respectively corresponding to the plurality of partial areas; and
a plurality of data driver circuits configured to generate, based on the plurality of gamma voltage data, a plurality of grayscale voltages to be applied to the plurality of data lines in the plurality of partial areas.

2. The display apparatus of claim 1, wherein the plurality of gamma voltage data correspond to a plurality of sample grayscales.

3. The display apparatus of claim 1, further comprising:
a reference gamma voltage generator configured to generate a first white voltage and a first black voltage of a first polarity, and a second white voltage and a second black voltage of a second polarity, wherein the second polarity is opposite to the first polarity with respect to a reference voltage,
wherein the reference gamma voltage generator is further configured to provide the plurality of data driver circuits with the first white voltage, the first black voltage, the second white voltage, and the second black voltage.

4. The display apparatus of claim 3, wherein each of the plurality of data driver circuits is configured to convert image data into a grayscale voltage using the first white voltage, the first black voltage, the second white voltage, the second black voltage, and the plurality of gamma voltage data.

5. The display apparatus of claim 4, wherein at least one of the data driver circuits is configured to drive the plurality of data lines in at least one of the partial areas.

6. The display apparatus of claim 4, wherein the plurality of partial areas comprises a central area of the display panel, a left side area which is located at a left side with respect to the central area, and a right side area which is located at a right side with respect to the central area.

7. The display apparatus of claim 6, wherein the plurality of data driver circuits comprises at least one first data driver circuit configured to drive the plurality of data lines in the central area, at least one second data driver circuit configured to drive the plurality of data lines in the left area, and at least one third data driver circuit configured to drive the plurality of data lines in the right area.

8. The display apparatus of claim 7, wherein the timing controller is configured to provide the first data driver circuit with a first gamma voltage data, and to provide the second and third data driver circuits with a second gamma voltage data which is different from the first gamma voltage.

9. The display apparatus of claim 7, wherein the timing controller is configured to provide the first data driver circuit with a first gamma voltage data,
to provide the second data driver circuit with a second gamma voltage data which is different from the first gamma voltage data, and
to provide the third data driver circuit with a third gamma voltage data which is different from the first and second gamma voltage data.

10. The display apparatus of claim 1, wherein each of the plurality of data lines is divided into an upper data line disposed in an upper area of the display panel and a lower data line disposed in a lower area of the display panel, the upper data line being spaced apart from the lower data line.

11. The display apparatus of claim 10, wherein the plurality of partial areas comprise a first central area, a first left side area, and a first right side area which are located in the upper area, and
a second central area, a second left side area, and a second right side area which are located in the lower area,
wherein the first left side area and the first right side area are located with respect to the first central area, and the second left side area and the second right side area are located with respect to the second central area.

12. The display apparatus of claim 11, wherein the plurality of data driver circuits comprise at least one first data driver circuit configured to drive the plurality of data lines in the first central area, at least one second data driver circuit configured to drive the plurality of data lines in the first left area, at least one third data driver circuit configured to drive the plurality of data lines in the first right area, at least one fourth data driver circuit configured to drive the plurality of data lines in the second central area, at least one fifth data driver circuit configured to drive the plurality of data lines in the second left area, and at least one sixth data driver circuit configured to drive the plurality of data lines in the second right area.

13. The display apparatus of claim 12, wherein the first to sixth data driver circuits are further configured to receive the plurality of gamma voltage data, with each data driver circuit receiving a different gamma voltage data.

14. The display apparatus of claim 13, further comprising:
a first timing controller configured to provide the first, second, and third data driver circuits with the plurality of gamma voltage data, and
a second timing controller configured to provide the fourth, fifth, and sixth driver circuits with the plurality of gamma voltage data.

15. The display apparatus of claim 14, wherein the first and second timing controllers are configured to provide the first and fourth data driver circuits with a plurality of first gamma voltage data, and
to provide the second, third, fifth, and sixth data driver circuits with a plurality of second gamma voltage data which are different from the first gamma voltage data.

16. The display apparatus of claim 14, wherein the first timing controller is configured to provide the first data driver circuit with a first gamma voltage data, to provide the second data driver circuit with a second gamma voltage data, and to provide the third data driver circuit with a third gamma voltage data, and
the second timing controller is configured to provide the fourth data driver circuit with a fourth gamma voltage data, to provide the fifth data driver circuit with a fifth gamma voltage data, and to provide the sixth data driver circuit with a sixth gamma voltage data.
